(19) United States
(12) Patent Application Publication
(10) Pub. No.: US 2007/0102980 A1
(43) Pub. Date: May 10, 2007

(54) Continuously adjustable stroller reclining mechanism

(76) Inventor: Hung-Tsun Chen, Taichung County (TW)

Correspondence Address: HUNG-TSUN CHEN, P.O. BOX 44-2049, Taipei, 10668, TW

(21) Appl. No.: 11/255,945

(22) Filed: Oct. 24, 2005

(51) Int. Cl. B60N 2/00

(52) U.S. Cl. 297/354.12

(57) ABSTRACT

A continuously adjustable stroller reclining mechanism includes a belt binder affixed to the backrest of the stroller seat. Two ends of a belt are affixed to the two supporting rods of the stroller. By using the belt binder, one can release the belt to adjust the inclination angle of the backrest to a desirable angle.

### BACKGROUND OF THE INVENTION

(1) Field of the Invention

The present invention relates generally to a baby stroller, and more particularly to a stroller reclining mechanism.

(2) DESCRIPTION OF THE PRIOR ARTS

A good baby stroller can provide comfortable rides for a baby and prevent parents from holding their baby all the time. Normally, the seat of a baby stroller can be reclined to various positions for a baby to sit and to lie down. However, most of the reclining mechanism of baby strollers is of mechanical nature, which allows only sectional adjustments. Such a conventional stroller reclining mechanism requires the combination of a locking device, an extension device, an elastic device, and a positioning device, which is structurally complicated and inconvenient to use. The users often need some practice to familiarize themselves the operations.

Accordingly, the inventor of the present invention has devoted himself to develop possible solutions for the drawbacks mentioned above. At last, a new stroller reclining mechanism is developed.

### SUMMARY OF THE INVENTION

One objective of the present invention is to provide a continuously adjustable stroller reclining mechanism that employs a belt binder to adjust the inclination angle, thereby satisfying the needs for babies of different size.

Accordingly, the continuously adjustable stroller inclination mechanism, which is applicable to a stroller that includes a backrest having a back plate and two supporting rods, a belt binder being disposed to the back plate and two ends of a belt being affixed to the two supporting rods, the belt binder comprising:

a main body having a positioning plate and a front plate, the positioning plate and the front plate forming a retaining space therebetween;

a pivotal shaft pivotally disposed in the retaining space of the main body, the pivotal shaft having an elastic element and a contact surface on the surface of the pivotal shaft; and

at least a belt, which penetrates the retaining space and is gripped between the contact surface of the pivotal shaft and the positioning plate of the main body;

whereby the pivotal shaft can be rotated to release the tightly contacted belt from the contact surface, so as to continuously adjust the inclination angle of the backrest to any desirable angle.

### BRIEF DESCRIPTION OF THE DRAWINGS

FIG. 1 is an explosive view of a stroller reclining mechanism of the present invention.

FIG. 2 is a perspective of the stroller reclining mechanism of the present invention.

FIG. 3 is a sectional view along 3-3 of FIG. 2.

FIG. 4 is a sectional view along 4-4 of FIG. 2.

FIG. 5 is a sectional view of the stroller reclining mechanism of the present invention when the belt is released,

FIG. 6 is a rear elevation of a stroller in combination with the stroller reclining mechanism of the present invention, and

FIG. 7 is aside elevation of a stroller in combination with the stroller reclining mechanism of the present invention.

### DETAILED DESCRIPTION OF THE PREFERRED EMBODIMENTS

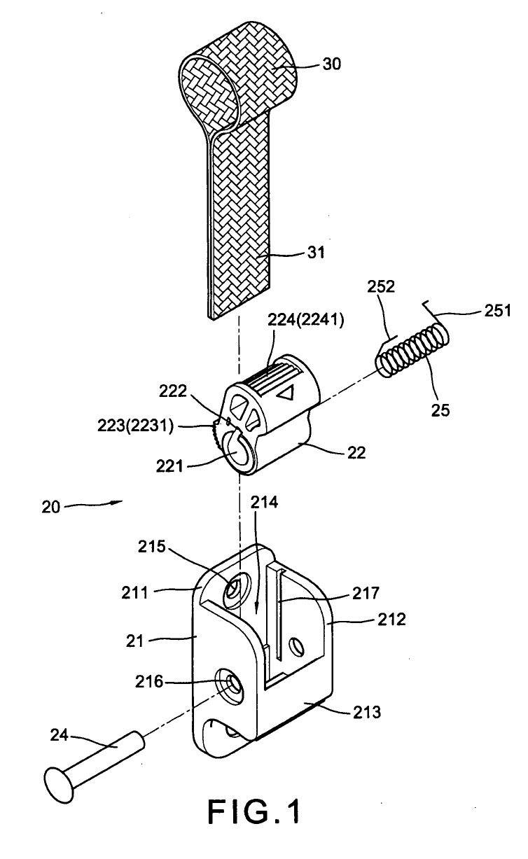

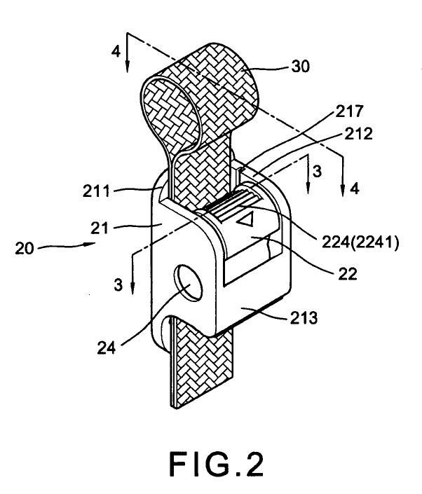

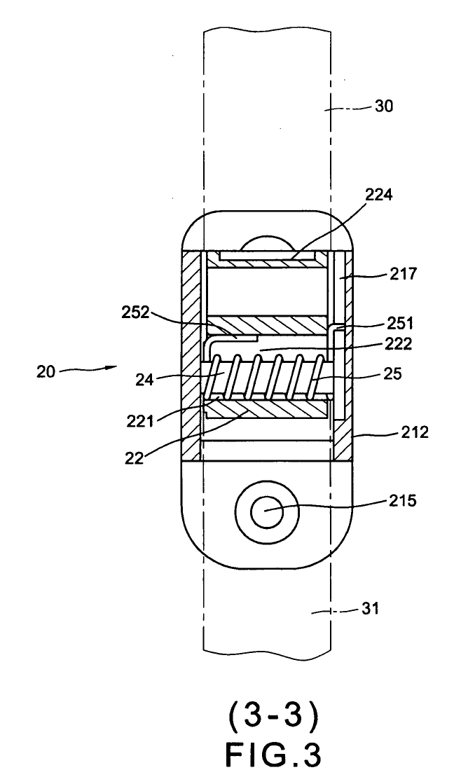

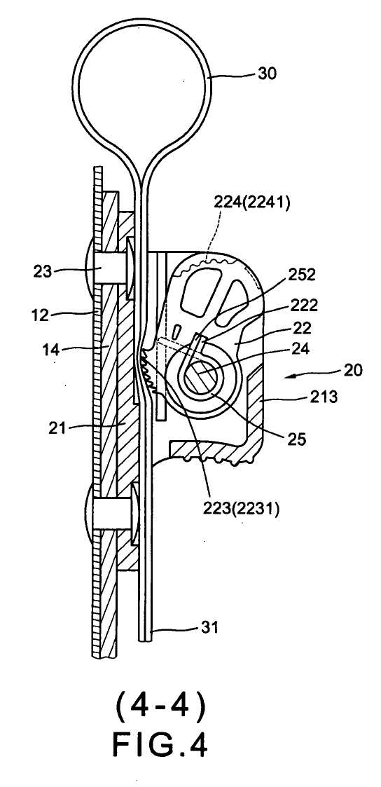

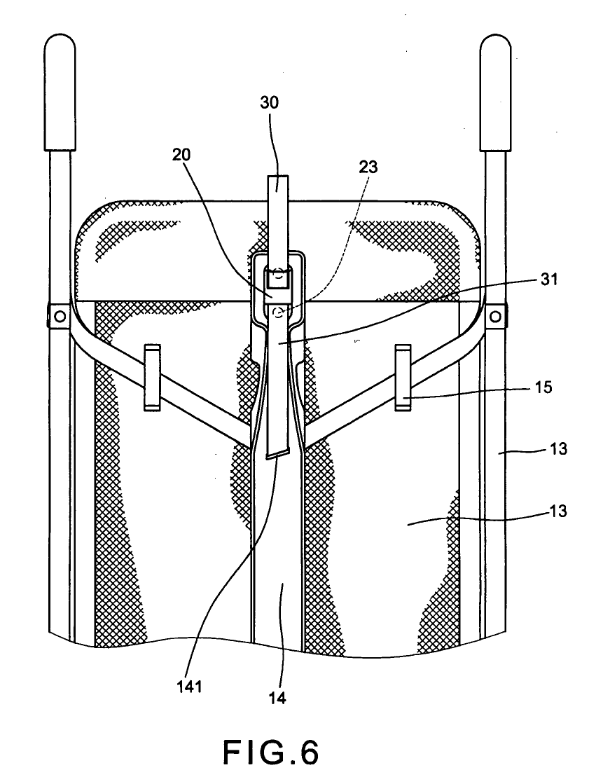

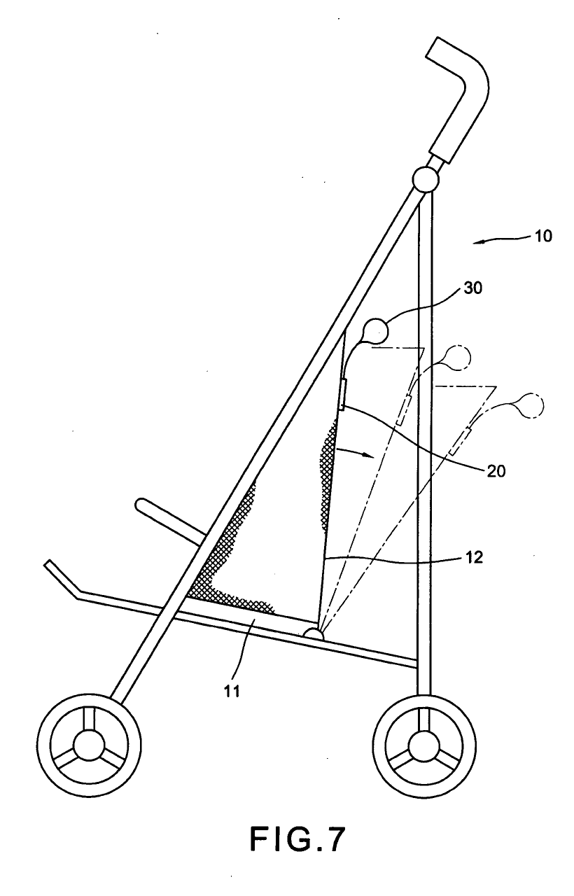

Referring to FIG. 1, FIG. 2, FIG. 3, FIG. 4, FIG. 6 and FIG. 7, a continuously adjustable stroller reclining mechanism of the present invention is illustrated. As shown, a stroller 10 includes a seat 11, which includes a movable backrest 12. The seat 11 further includes two supporting rods 13 extended from the hand holder. A belt binder 20 is affixed to the backrest 12, and two ends of a belt 30 are affixed to the two supporting rods 13. The belt binder 20 includes a main body 21 and a pivotal shaft 22. The main body 21 includes a positioning plate 211, two side plates 212 and a front plate 213. A retaining space 214 is formed between the positioning plate 211 and the front plate 213. The front plate 213 is lower than the positioning plate 211. Two holes 215 are formed on the upper and the lower portion of the positioning plate 211 of the main body 21, thereby allowing a riveting pillar 23 to connect to the backrest 12 of the seat 11. A hole 216 is formed on each of the two side plates 212, thereby providing a riveting pillar 24 to penetrate therethrough. The riveting pillar 24 also penetrates through the shaft hole 221 of the pivotal shaft 22, which allows the pivotal shaft 22 to be pivotally disposed in the retaining space 214 of the main body 21. One side plate 212 of the main body 21 includes a trench 217 on the inner surface thereof, while the shaft hole 221 of the pivotal shaft 22 includes a positioning groove 222. The trench 217 of the side plate 212 provides one end 251 of an elastic element 24 to lock therein. In one particular embodiment, the elastic element 24 is a spring. The positioning groove 222 of the pivotal shaft 22 provides another end 252 of the elastic element 25 to be affixed therein. The elastic element 25 enables the pivotal shaft 22 to comprise elasticity and recoverable to its original position.

The surface of the pivotal shaft 22 includes a contact surface 223. The contact surface 223 comprises a plurality of tilted protrusive teeth 2231. Once the tilted protrusive teeth 2231 contact and press on the belt 30, they can tightly grip the belt 30. A compressive portion 224 is protrusively formed above the pivotal shaft 22. The compressive portion 224 is of an arc shape, the surface of which includes a plurality of horizontal humps 2241. The horizontal humps 2241 can prevent slippery of user's fingers. The belt 30 is folded to dispose in the retaining space 214 of the main body 21. The folded belt 30 is tightly pressed by the contact surface 223 of the pivotal shaft 22 and the positioning plate 211 of the main body 21.

According to the description given above, the continuously adjustable stroller reclining mechanism of the present invention can adjust the angle of the backrest 12 of the seat 11 by adjusting the tightness of the belt 30 via the belt binder 20. As shown in FIG. 2, FIG. 6, and FIG. 7, the belt binder 20 is riveted on the back portion of the backrest 12 of the seat 11. The belt 30 penetrates through the retaining space 214 of the belt binder 20. Two ends of the belt 30 penetrates in the through hole 141 of the backrest 12 stripe 14 and penetrates out of the through hole 141, and further penetrates in and out of a positioning stripe 15. Two ends 31 of the belt 30 are riveted to the two supporting rods 13 of the stroller 10. It is noted that the two supporting rods 13 do not connect with the backrest 12. The belt binder 20 can tightly grip the belt 30 to support the backrest 12. The backrest 12 is then inclined to an angle, such that the backrest 12 can stay in position when a baby is riding the stroller 10.

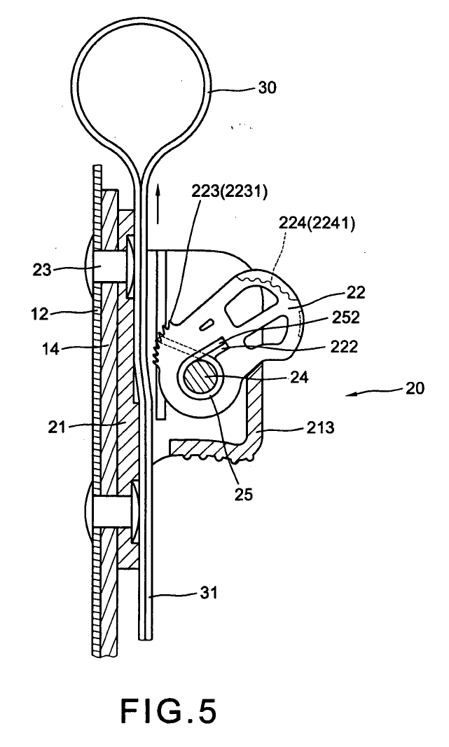

When one wants to adjust the inclination angle of the backrest 12, as shown in FIG. 4 and FIG. 5, one can press the compressive portion 224 of the pivotal shaft 22 and rotate the pivotal shaft 22 until the pivotal shaft 22 reaches the front plate 213. The contact surface 223 will move upward and leave the belt 30, so as to release the belt 30. One can then continuously adjust the backrest 12 to a desirable angle by pulling the belt 30 upward or by pulling the two ends 31 of the belt 30 downward. Once the compressive portion 224 is released, the pivotal shaft 22 will recover to its original position due to the presence of the elastic element 25. The pivotal shaft 22 can be pushed further to enhance the tightness of the contact surface 223 gripping the belt 30. Since the tilted protrusive teeth 2231 on the contact surface can prevent reverse motion (i.e. the backward force of the backrest 12 on the two ends 31 of the belts 30), the belt 30 is tightly gripped. The backrest 12 of the seat is then successfully adjusted to the desired inclination angle. Consequently, when the top portion of the belt 30 is longer and the two ends 31 of the belt 30 are shorter, the backrest 12 is more forwardly inclined. On the contrary, when the top portion of the belt 30 is shorter and the two ends 31 of the belt 30 are longer, the backrest 12 is more backwardly inclined.

If an external force is exerted on the backrest 12, the stripe 14 and the two positioning stripes 15 will restrict the movement of the backrest 12. Therefore, one needs not to worry about the movement of the backrest 12.

In conclusion, the stroller inclination mechanism of the present invention is advantageous in that it requires neither any additional mechanical device nor complicated assembly process. The operation of the stroller inclination mechanism of the present invention is also very easy. In addition, no mechanical locking device is present to harm anyone, which will bring safety to the user. Moreover, the stroller inclination mechanism of the present invention can be adjusted continuously, such that any desirable angle of the backrest 12 can be obtained to comply with the needs of a growing baby.

While the invention has been described by means of specific embodiments, numerous modifications and variations could be made thereto by those skilled in the art without departing from the scope and spirit of the invention set forth in the following claims.

What is claimed is:

1. A continuously adjustable stroller inclination mechanism, which is applicable to a stroller that includes a backrest having a back plate and two supporting rods, a belt binder being disposed to the back plate and two ends of a belt being affixed to the two supporting rods, the belt binder comprising:
a main body having a positioning plate and a front plate, the positioning plate and the front plate forming a retaining space therebetween;
a pivotal shaft pivotally disposed in the retaining space of the main body, the pivotal shaft having an elastic element and a contact surface on the surface of the pivotal shaft; and
at least a belt, which penetrates the retaining space and is gripped between the contact surface of the pivotal shaft and the positioning plate of the main body;
whereby the pivotal shaft can be rotated to release the tightly contacted belt from the contact surface, so as to continuously adjust the inclination angle of the backrest to any desirable angle.

2. The mechanism of claim 1, wherein the main body further comprises two side plates, the pivotal shaft being pivotally connected therewith via a riveting pillar.

3. The mechanism of claim 1, wherein the contact surface of the pivotal shaft comprises a plurality of tilted protrusive teeth.

4. The mechanism of claim 1, wherein the other end of the pivotal shaft comprises a compressive portion protrusively formed thereon, the surface of the compressive portion comprising a plurality of horizontal humps.

5. The mechanism of claim 1, wherein the elastic element of the pivotal shaft comprises a spring.

6. The mechanism of claim 1, wherein a trench is formed on the main body and a positioning groove is formed on the pivotal shaft, thereby locking one end of the elastic element in the trench and positioning the other end of the elastic element in the positioning groove.

7. The mechanism of claim 1, wherein a plurality of holes is formed on the positioning plate of the main body, thereby riveting the mechanism to the backrest of the seat.
